(19) United States
(12) Patent Application Publication
(10) Pub. No.: US 2016/0275402 A1
(43) Pub. Date: Sep. 22, 2016

(54) DETERMINING MODEL QUALITY

(71) Applicant: HEWLETT-PACKARD DEVELOPMENT COMPANY, L.P., Houston, TX (US)

(72) Inventors: Hava Babay Adi, Yehud (IL); Hagar Dinur, Yehud (IL); Hadas Avraham, Yehud (IL)

(21) Appl. No.: 15/033,151

(22) PCT Filed: Oct. 31, 2013
(86) PCT No.: PCT/US13/67790

§ 371 Date: Apr. 29, 2016

(51) Int. Cl. G06N 5/04; G06F 17/30

(52) U.S. Cl. CPC G06N 5/04; G06F 17/30958

(57) ABSTRACT

Determining model quality can include receiving data associated with a use of an information technology (IT) process record model. A quality of the IT process record model can be determined based on the data associated with the use of the IT process record model.

### BACKGROUND

Models, such as information technology (IT) process record models, can provide steps for handling a process in a particular way. Some examples of IT process record models can provide a task plan for creating a new employee in a system, giving permissions, installing a new laptop, etc. Models can be stored in a catalog and accessed based on a particular process that is to be handled.

### BRIEF DESCRIPTION OF THE DRAWINGS

FIG. 1 illustrates a screen shot of a user interface for determining model quality according to the present disclosure.

FIG. 2 illustrates a diagram of an example of a system for determining model quality according to the present disclosure.

FIG. 3 illustrates a diagram of an example of a computing device for determining model quality according to the present disclosure.

FIG. 4 illustrates a flow diagram of an example of a method for determining model quality according to the present disclosure.

### DETAILED DESCRIPTION

IT process record models can be maintained in a catalog that is accessible by an entity. The IT process record models can be accessed for reference when handling a process in a particular way. The IT process record model can be defined as a task plan that includes steps for handling the process in the particular way. In some examples, as discussed herein, the process can include creating a new employee in a system, giving permissions, installing a new laptop, etc. As such, a large number of models may exist in a catalog to handle various processes.

As a result of the number of models included in a catalog, management of the models can be made difficult. In some examples, a model may not contain current practices for dealing with a process and/or may contain incorrect practices for dealing with a process. Without a way to determine a performance associated with each model, over time a catalog can be filled with models that are out of date and/or do not include correct instructions for handling a process in a particular way.

Examples of the present disclosure can include receiving data associated with a use of an IT process record model. Examples of the present disclosure can include determining a quality of the IT process record model based on the data associated with the use of the IT process record model.

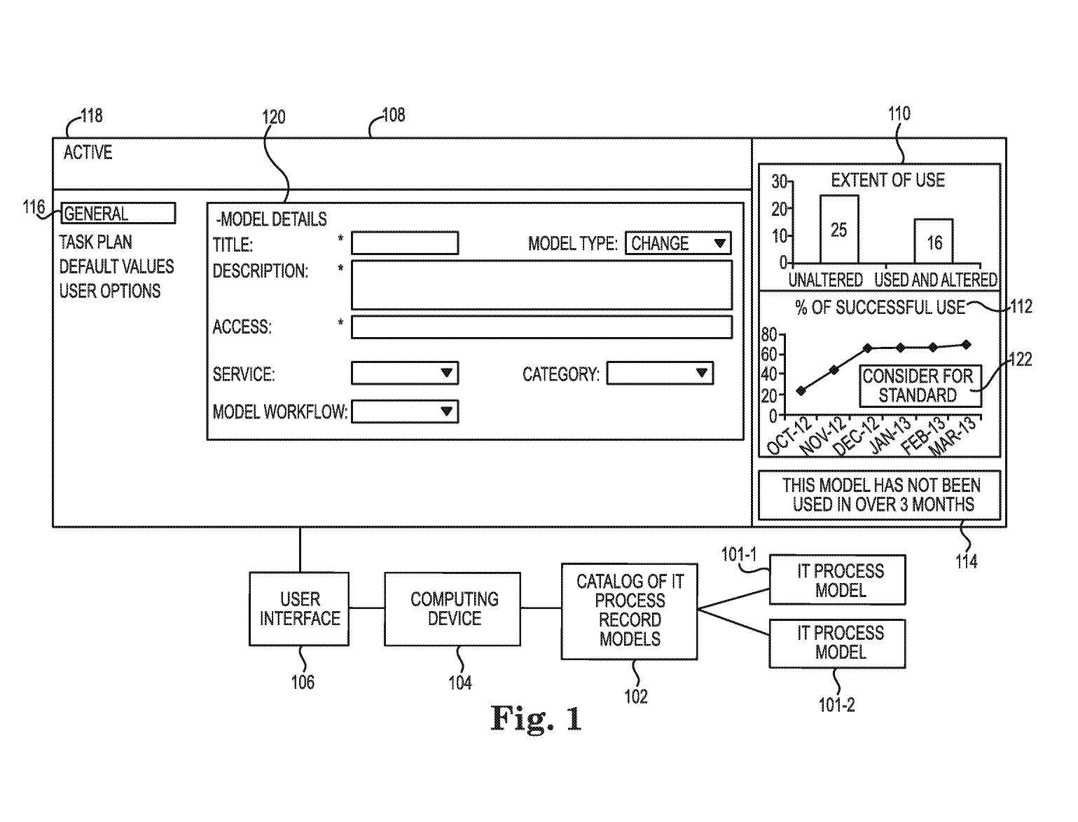

FIG. 1 illustrates an environment for determining model quality according to the present disclosure. The system can include a catalog of IT process record models 102, which can be defined as a database that stores a plurality of IT process record models 101-1, 101-2, hereinafter generally referred to as IT process record models 101. The system can include a computing device 104 that can access the IT process record models 101 stored in the catalog 102 and can perform various determinations regarding the IT process record models 101, as discussed herein. The system can include a user interface 106, which can display the IT process record models 101 and data associated with the IT process models 101 on a view and edit page 108.

Examples of the present disclosure can receive data associated with an IT process record model 101 and can determine a quality of the IT process record model 101. The quality of the IT process record model 101 can be defined as an ability to handle a process in a particular way with the IT process record model 101. In an example, if following the model results in successfully handling the process in the particular way with no deviation made from the IT process record model 101, the quality associated with the IT process record model 101 can be higher than if deviations are made from the IT process record model 101 to handle the process. In addition, in an example, if following the IT process record model 101 results in successfully handling the process without creating an incident, as discussed herein, the quality of the IT process record model 101 can be greater than if a number of incidents are created after following the IT process record model 101. In addition, quality of the IT process record model 101 can be based on when the model was last used. For example, a model that has not been used for three years can be associated with a lower quality than a model that was used one day ago.

The determination of the quality of the IT process record model 101 can be made based on the data associated with the IT process model 101 such as an amount that the IT process record model 101 is modified before use, an amount of incidents that are opened after the IT process record model 101 is used, and a time since the IT process record model 101 was last used, for example.

Based on the statistics, a determination can be made of whether the IT process record model 101 should be modified. Modifications to the IT process record model 101 can include, for example, adjusting an approval level associated with use of the IT process record model 101; modifying a content of the IT process record model 101; and/or removing the IT process record model 101 from a catalog of IT process record models 102. As such, the catalog of IT process record models 102 can be reviewed and kept up to date based on the received data associated with the IT process record models 101.

Examples of the present disclosure can include receiving data associated with a use of an IT process record model 101. The data associated with the use of the IT process record model 101 can include an amount that the IT process record model 101 is modified before use. In some examples, before use of the IT process record model 101, a record can be generated that is associated with a process that is to be handled with the IT process record model 101 and a copy of the IT process record model 101 can be created. The record can be created by an individual (e.g., owner of the record) and the individual that created the record can modify the copy of the IT process record model 101 in case it needs an adjustment to handle with the process.

For example, where the process is installing a new laptop, a task plan associated with the copy of the IT process record model 101 can be modified by the individual if the IT process record model 101 is for installing a laptop with an outdated version of an operating system. Accordingly, the IT process record model 101 can be modified to align with procedures for installing a laptop with a current version of an operating system. An indicator can be associated with the IT process record model 101 that indicates that the copy of the IT process record model 101 is modified and/or indicates what is modified in the copy of the IT process record model 101. A count can be maintained for how many times the IT process record model 101 is modified.

In some examples, the amount that the IT process record model 101 is modified before use can include a number of times that the IT process record model 101 is modified before use versus a number of times that the IT process record model 101 is used unmodified. In some examples, the amount that the IT process record model 101 is modified can indicate a quality of the IT process record model 101 and/or can indicate how generic the IT process record model 101 is. For example, in a case where the IT process record model 101 is modified before every use, this may indicate that the IT process record model 101 does not provide an effective task plan for handling a process because the IT process record model 101 has to be modified to accord with an actual procedure for handling the process. Alternatively, in a case where the IT process record model 101 remains unmodified for every use, this may indicate that the IT process record model 101 does provide an effective task plan for handling a process because the IT process record model 101 does not have to be modified to accord with an actual procedure for handling the process.

As discussed herein, when the IT process record model 101 is modified for use, a copy of the IT process record model 101 can be created from an original state of the IT process record model 101 stored in the catalog of IT process record models 102. In some examples, the copy of the IT process record model 101 can include a copy of a task plan included in the IT process record model. The copy of the IT process record model 101 can then be modified. For instance, the original state of the IT process record model 101 (e.g., original version of the task plan) can remain in its original unmodified state, while the copy of the IT process record model 101 (e.g., copy of the task plan) is modified. As such, when a record is generated to handle a process with the IT process record model 101, a copy of the IT process record model 101 can be created from the original state of the IT process record model 101 stored in the catalog of IT process record models 102, which can then be modified for use. The original state of the IT process record model 101 can be maintained for generating additional copies of the IT process record model 101.

In some examples, the data associated with the use of the IT process record model 101 can include an amount that the IT process record model 101 is modified from an original state. The original state of the IT process record model 101 can be defined as an unmodified version of the IT process record model 101, as stored in the catalog of IT process record models 102. As discussed herein, a portion of a task plan included in the IT process record model 101 can be modified to handle a particular process and an indicator can indicate what is modified in the IT process record model 101 to handle the particular process. As such, a percentage of the IT process record model 101 that was modified from the original state can be determined.

When the percentage of the IT process record model 101 that was modified from the original state is greater (e.g., 100 percent of the IT process record model 101 was modified), this can indicate a lower quality associated with the IT process record model 101. Alternatively, when the percentage of the IT process record model 101 that was modified from the original state is lower (e.g., 1 percent of the IT process record model 101 was modified), this can indicate a higher quality associated with the IT process record model 101.

Examples of the present disclosure can include determining a threshold associated with the amount that the IT process record model 101 is modified before use and providing an indication to modify the IT process record model 101 when the threshold is exceeded. In some examples, the threshold can be set as a ratio of times that the IT process record model 101 is modified versus the times that the IT process record model 101 is used unmodified, for example. Alternatively, the threshold can be set as a percentage of the IT process record model 101 that was modified from the original state, for example. The threshold can be set by a user and/or administrator of the catalog 102.

When modification of the IT process record model 101 exceeds the threshold, this can be an indicator that the quality of the IT process record model 101 has degraded to a point where the IT process record model 101 may not provide an effective task plan to handle a process. As such, the indication to modify the IT process record model 101 can be provided to the user and/or administrator of the catalog of IT process record models 102. Alternatively, an indication that the threshold has been exceed can be provided to the user and/or administrator of the catalog of IT process record models 102.

Examples of the present disclosure can include modifying the original state of the IT process record model in response to a determination that the amount the IT process record model is modified from the original state exceeds the threshold level of modification. As discussed herein, an indicator can be associated with the IT process record model 101 that indicates what is modified in a copy of the IT process record model 101. As such, the modified portions of the copy of the IT process record model 101 can be determined and used to modify the IT process record model 101 in the original state. In some examples, the IT process record model 101 in the original state can be modified automatically based on the modified portions of the copy of the IT process record model 101.

In some examples, a particular portion of the IT process record model 101 to modify can be indicated in response to the determination that the amount the IT process record model 101 is modified from the original state exceeds the threshold level of modification. The indicator that indicates what is modified in a copy of the IT process record model 101 can be used to determine what should be modified in the IT process record model 101 in the original state in order to make a portion of the IT process record model 101 in the original state match the copy of the IT process record model 101, in an example.

In some examples, the data associated with the use of the IT process record model 101 can include an amount of incidents that are opened after the IT process record model 101 is used. In an example, an incident can be defined as an item that needs resolution after use of the IT process record model 101. An incident can be opened if a failure is caused by use of the IT process record model 101; if part of a procedure is missing; if use of the IT process record model 101 did not successfully handle the particular process, etc.

A greater number of incidents opened after an IT process record model 101 is used can indicate a lower quality associated with the IT process record model 101 than when a lesser number of incidents are opened after the IT process model 101 is used. For example, when the IT process record model 101 provides a successful resolution when handling a process, no incidents may be opened, thus indicating a higher quality associated with the IT process record model 101.

Examples of the present disclosure can increase an approval level associated with use of the IT process record model 101 when the amount of incidents that are opened after use of the IT process record model 101 exceeds a threshold. When an incident is opened, the incident may have to be addressed by IT staff, thus causing an additional amount of work. As such, it may be desirable to limit use of an IT process record model 101 to users who have experience with the IT process record model 101. Embodiments of the present disclosure can increase an approval level associated with use of the IT process record model 101 when the amount of incidents that are opened exceeds a threshold, which can limit users of the IT process record model 101 and/or limit users of the IT process record model 101 to users who have experience with the IT process record model 101. As such, by increasing the approval level, use of the IT process record model 101 can be limited to particular users, thus resulting in fewer opened incidents.

Alternatively, examples of the present disclosure can decrease an approval level associated with use of the IT process record model 101 when the amount of incidents that are opened after use of the IT process record model 101 does not exceed the threshold. An IT process record model 101 that results in a number of incidents that are opened after use that does not exceed a threshold may not create extra work for IT staff. In some examples, where use of the IT process record model 101 results in zero incidents being opened after use, no extra work may be created for IT staff. As such, a risk associated with allowing a user with a lower approval level to use the IT process record model 101 may not be great. The IT process record model 101 can therefore be used by a greater number of users without necessarily opening a greater number of incidents.

In some examples, the data associated with the use of the IT process record model 101 can include a time since the IT process record model 101 was last used. A greater time since the IT process record model 101 was last used can indicate a lower quality associated with the IT process record model 101. If an IT process record model 101 has not been used for three years, the model may no longer be useful and/or up to date and may not serve a purpose by including the model in the catalog 102. As such, a quality associated with the IT process record model 101 may be lower. Alternatively, if an IT process record model 101 was used one day ago, the model may still be current and may serve a purpose by including the model in the catalog 102. A quality associated with the IT process record model 101 may therefore be higher.

In some examples, an indication can be made that the IT process record model 101 should be reviewed when the time since the last use of the IT process record model 101 exceeds a threshold. The indication can include a message displayed on a user interface, in an example, that notifies an administrator and/or user of the IT process record model 101 that it should be reviewed. The IT process record model 101 can be reviewed to determine whether the IT process record model 101 is still relevant, in some examples. For instance, procedures and/or a task plan associated with the model can be reviewed to see why the model has not been used and/or can be modified to make the model relevant.

Examples of the present disclosure can include determining that the IT process record model 101 has not been used within a threshold time and removing the IT process record model from the catalog of IT process record models 101 in response to the determination that the IT process record model 101 has not been used within the threshold time. In an example, the IT process record model 101 can be removed automatically when the IT process record model 101 has not been used within the threshold time. By removing the IT process record model 101 if it has not been used within the threshold time, the catalog of IT process record models can be kept up to date.

Examples of the present disclosure can include determining a quality of the IT process record model 101 based on the data associated with the use of the IT process record model 101. In some examples, the quality of the IT process record model 101 can be based on the amount that the IT process record model 101 is modified before use. As discussed herein, the quality associated with the IT process record model 101 can be indicated as lower the more the IT process record model 101 is modified before use. Alternatively, the quality associated with the IT process record model 101 can be indicated as higher the less the IT process record model 101 is modified before use. Modification of the IT process record model 101 before use can suggest that corrections and/or updates to the IT process model 101 were necessary before the model was used, which can indicate that the model is not correct and/or is not up to date, for example.

In addition, the quality of the IT process record model 101 can be based on an amount of incidents that are opened after the IT process record model 101 is used. As discussed herein, a greater number of incidents opened after an IT process record model 101 is used can indicate a lower quality associated with the IT process record model 101 than when a lesser number of incidents are opened after the IT process model 101 is used.

The quality of the IT process record model 101 can be based on a time since the IT process record model 101 was last used, as discussed herein. A greater time since the IT process record model 101 was last used can indicate a lower quality associated with the IT process record model 101 and a lesser time since the IT process record model 101 was last used can indicate a higher quality associated with the IT process record model 101.

Examples of the present disclosure can include determining a metric associated with the quality of the IT process record model 101 and displaying the metric associated with the quality of the IT process record model. In some examples, the metric can include letters and/or numbers. For example, the metric can include letters A to F, which can represent a highest quality to a lowest quality respectively. Alternatively, the metric can include numbers from 10 to 1 representing a highest quality to a lowest quality, respectively.

In some examples, the metric associated with the quality of the IT process record models 101 can be a graph displayed on the view and edit page 108. The graph can be an extent of use graph 110, a percent of successful use graph 112, etc. The extent of use graph 110 can represent an amount that the IT process record model 101 has been modified before use. As shown, the IT process record model 101 has been used unaltered 25 times and has been used and altered 16 times. Displaying the extent of use graph to a user can assist the user in determining whether the IT process record model 101 is up to date, for example.

The graph can also be a percent of successful use graph 112, which can represent a number of times that the IT process record model 101 was used successfully versus time, in some examples. As shown in FIG. 1, the percent of successful use graph 112 represents a percentage of times that the IT process record model 101 was used successfully in each of a number of months. For example, the IT process record model 101 was used successfully (e.g., without opening an incident and/or opening less than a threshold of incidents) in October 2012 20 percent of the time, in November 2012 40 percent of the time, etc.

The graph can display an approval recommendation 122 based on how successfully the IT process model 101 is used. As shown in FIG. 1, the approval recommendation 122 recommends a standard approval for the model based on the percentage of successful use. In some examples, an average of the percent of successful use can be determined and the approval recommendation 122 can be based off of the average. In an example, if the average exceeds a threshold of percentage of successful use (e.g., is used successfully an average of 99 percent of the time), the approval recommendation 122 can recommend a minimum approval level. Alternatively, if the average is below a threshold of percentage of successful use (e.g., is used successfully an average of 1 percent of the time), the approval recommendation 122 can recommend a maximum approval level, in some examples.

In some examples, the metric associated with the quality of the IT process record models 101 can include a metric associated with a time since the IT process record model 101 was last used and can be presented on the view and edit page 108 as last used metric 114. As shown in FIG. 1, the last used metric 114 can display the time since the IT process record model 101 was last used, which can be helpful to a user of the IT process record model 101 when determining whether to remove the model from the catalog of IT process record models 102, for example.

As discussed herein, the metric associated with the quality of the IT process record model can be displayed on the view and edit page 108. In addition, the view and edit page can include an activity indicator 118. The activity indicator 118 can indicate whether the model is active or inactive. In some examples, the model can be inactive if it has been deleted from the catalog of IT process record models 102 and can be active if it is currently in the catalog of IT process record models 102.

The view and edit page 108 can include a model details portion 120. The model details portion 120, which can include a title field, description field, access field, as well as drop down menus for service, model workflow, model types, and categories of IT process record model 101. In addition, the view and edit page 108 can include tabs, which can be selected to view and/or edit settings and/or data associated with the IT process record model. As shown in FIG. 1, the general tab 116 is selected, however a task plan tab, default values tab, and user options tab can be included in the view and edit page 108, in some examples. Selection of the task plan tab can display the task plan that describes the steps to be executed for handling the process. Selection of the default values tab can provide fields that can be displayed for entering default values in IT process record models 101, which can be used for automatic assignment of IT process record models 101 associated with a particular process to a group of users. Selection of the user options tab can display information and/or fields for entering information from a user in order to execute IT process record models 101.

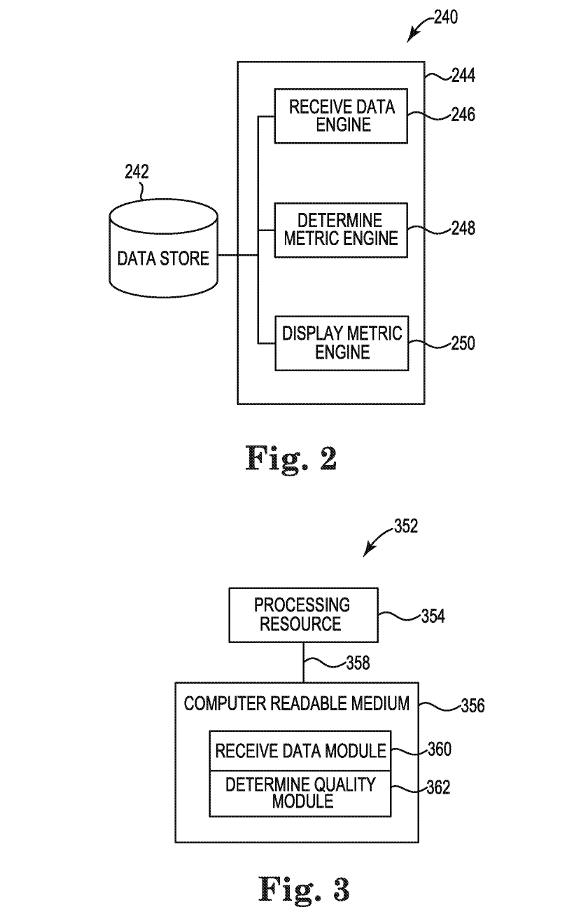

FIG. 2 illustrates a diagram of an example of a system 240 for determining model quality according to the present disclosure. The system 240 can include a data store 242, a determining system 244, and/or a number of engines. The system 240 can be in communication with the data store 242. In some examples, the determining system 244 can include a number of engines (e.g., receive data engine 246, determine metric engine 248 display metric engine 250, etc.). The number of engines can include hardware and/or combinations of hardware and programming to perform functions provided herein. The providing system 244 can include additional or fewer engines than illustrated to perform the various functions.

The receive data engine 246 can receive data associated with a use of an IT process record model. In some examples, the data can include an amount that the IT process record model is modified from an original state. In addition, the data can include an amount of incidents that are opened after the IT process record model is used and/or a time since the IT process record model was last used.

The determine metric engine 248 can determine a metric associated with a quality of the IT process record model based on the data associated with the use of the IT process record model. As discussed herein, the metric associated with the quality of the IT process record model can include a single value in some examples. The data associated with the use of the IT process record model can be analyzed and a single value can be determined to represent the quality of the IT process record model. For instance, the value can be a number between 1 and 100, with a quality of the model increasing with higher values. In addition, the metric can be displayed as a graph, as discussed herein.

The display metric engine 250 can display the metric associated with the quality of the IT process record model. The metric associated with the quality of the IT process record model can be displayed on a view and edit page associated with the IT process record model, in some examples. By displaying the metric on the view and edit page, a user can view the metric and make a decision whether to edit the IT process record model on the view and edit page. In some examples, the user can view the metric and edit the IT process record model concurrently.

FIG. 3 illustrates a diagram of an example of a computing device 352 for providing resources to customers according to the present disclosure. The computing device 352 can utilize software, hardware, firmware, and/or logic to perform a number of functions described herein.

The computing device 352 can be a combination of hardware and instructions to share information. The hardware, for example can include a processing resource 354 and/or a memory resource 356 (e.g., computer-readable medium (CRM), database, etc.). A processing resource 354, as used herein, can include a number of processors capable of executing instructions stored by a memory resource 356. Processing resource 354 can be integrated in a single device or distributed across multiple devices. The instructions (e.g., computer-readable instructions (CRI)) can include instructions stored on the memory resource 356 and executable by the processing resource 354 to implement a particular function (e.g., determining model quality, etc.).

The memory resource 356 can be in communication with the processing resource 354. A memory resource 356, as used herein, can include a number of memory components capable of storing instructions that can be executed by processing resource 354. Such a memory resource 356 can be a non-transitory CRM. The memory resource 356 can be integrated in a single device or distributed across multiple devices. Further, the memory resource 356 can be fully or partially integrated in the same device as the processing resource 354 or it can be separate but accessible to that device and the processing resource 354. Thus, it is noted that the computing device 352 can be implemented on a user device and/or a collection of user devices, on a mobile device and/or a collection of mobile devices, and/or on a combination of the user devices and the mobile devices.

The memory resource 356 can be in communication with the processing resource 354 via a communication link 358 (e.g., path). The communication link 358 can be local or remote to a computing device associated with the processing resource 354. Examples of a local communication link 358 can include an electronic bus internal to a computing device where the memory resource 356 is one of a volatile, non-volatile, fixed, and/or removable storage medium in communication with the processing resource 354 via the electronic bus.

The memory resource 356 can include a number of modules such as a scan module receive data module 360 and determine quality module 362. The number of modules 360, 362 can include CRI that when executed by the processing resource 354 can perform a number of functions. The number of modules 360, 362 can be sub-modules of other modules. For example, the receive data module 360 and the determine quality module 362 can be sub-modules and/or contained within the same computing device. In another example, the number of modules 360, 362 can comprise individual modules at separate and distinct locations (e.g., CRM, etc.).

Each of the number of modules 360, 362 can include instructions that when executed by the processing resource 354 can function as a corresponding engine as described herein. For example, the receive data module 360 can function as receive data engine 246, and the receive data module 360 can receive data associated with a use of an IT process record model.

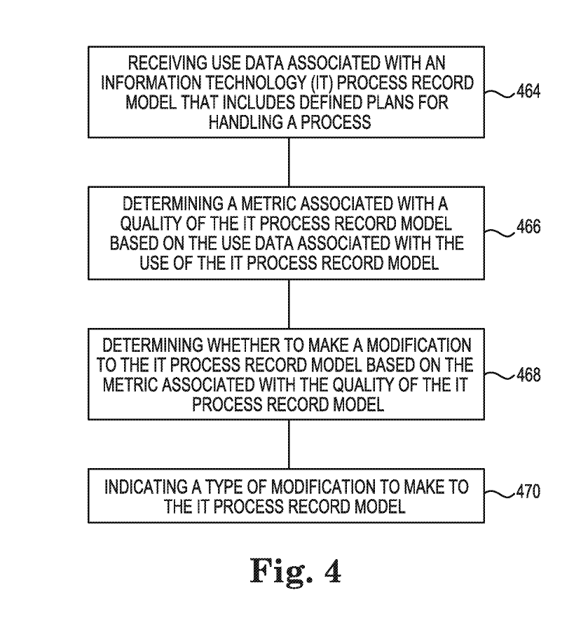

FIG. 4 illustrates a flow diagram of an example of a method for determining model quality. The method can include receiving 464 use data associated with an IT process record model that includes defined plans for handling a process. In an example, the defined plans for handling the process can include instructions for how to handle the process. For instance, the instructions can include step by step instructions for how to add an employee to a system and/or how to install a laptop, for example.

The method can include determining 466 a metric associated with a quality of the IT process record model based on the use data associated with the use of the IT process record model. In some examples, the quality of the IT process record model can be based on the amount that the IT process record model is modified before use. In addition, the quality of the IT process record model can be based on an amount of incidents that are opened after the IT process record model is used. The quality of the IT process record model can also be based on a time since the IT process record model was last used, as discussed herein.

The method can include determining 468 whether to make a modification to the IT process record model based on the metric associated with the quality of the IT process record model. In some examples, the modification can include adjusting an approval level associated with use of the IT process record model; modifying a content of the IT process record model; and/or removing the IT process record model from a catalog of IT process record models.

The method can include indicating 470 a type of modification to make to the IT process record model. In some examples, indicating the type of modification to make to the IT process record model can include displaying the type of modification to make to the IT process record model on an edit page associated with the IT process record model.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

As used herein, “a” or “a number of” something can refer to one or more such things. For example, “a number of widgets” can refer to one or more widgets.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A non-transitory computer-readable medium storing instructions executable by a computer to cause the computer to:
receive data associated with a use of an information technology (IT) process record model; and
determine a quality of the IT process record model based on the data associated with the use of the IT process record model.

2. The medium of claim 1, wherein the data associated with the use of the IT process record model includes an amount that the IT process record model is modified before use.

3. The medium of claim 2, wherein the amount that the IT process record model is modified before use includes a number of times that the IT process record model is modified before use versus a number of times that the IT process record model is used unmodified.

4. The medium of claim 3, including instructions to:
determine a threshold associated with the amount that the IT process record model is modified before use; and
provide an indication to modify the IT process record model when the threshold is exceeded.

5. The medium of claim 1, wherein the data associated with the use of the IT process record model includes an amount of incidents that are opened after the IT process record model is used.

6. The medium of claim 5, including instructions executable to:
increase an approval level associated with use of the IT process record model when the amount of incidents that are opened after use of the IT process record model exceeds a threshold; and
decrease an approval level associated with use of the IT process record model when the amount of incidents that are opened after use of the IT process record model does not exceed the threshold.

7. The medium of claim 1, wherein the data associated with the use of the IT process record model includes a time since the IT process record model was last used.

8. The medium of claim 8, including instructions executable to indicate that the IT process record model should be reviewed when the time since the last use of the IT process record model exceeds a threshold.

9. A system comprising:
a receive data engine to receive data associated with a use of an information technology (IT) process record model, wherein the data includes an amount that the IT process record model is modified from an original state;
a determine metric engine to determine a metric associated with a quality of the IT process record model based on the data associated with the use of the IT process record model; and
a display metric engine to display the metric associated with the quality of the IT process record model.

10. The system of claim 10, including an engine to:
determine whether the amount that the IT process record model is modified from the original state exceeds a threshold level of modification; and
modify the original state of the IT process record model in response to a determination that the amount the IT process record model is modified from the original state exceeds the threshold level of modification.

11. The system of claim 11, including an engine to indicate a particular portion of the IT process record model to modify in response to the determination that the amount the IT process record model is modified from the original state exceeds the threshold level of modification.

12. The system of claim 10, including an engine to:
determine that the IT process record model has not been used within a threshold time; and
remove the IT process record model from a catalog of IT process record models in response to the determination that the IT process record model has not been used within the threshold time.

13. A method, comprising:
receiving use data associated with an information technology (IT) process record model that includes defined plans for handling a process;
determining a metric associated with a quality of the IT process record model based on the use data associated with the use of the IT process record model;
determining whether to make a modification to the IT process record model based on the metric associated with the quality of the IT process record model; and
indicating a type of modification to make to the IT process record model.

14. The method of claim 13, wherein the modification includes at least one of adjusting an approval level associated with use of the IT process record model; modifying a content of the IT process record model; and removing the IT process record model from a catalog of IT process record models.

15. The method of claim 13, wherein the method includes displaying the type of modification to make to the IT process record model on an edit page associated with the IT process record model.
